(19) United States
(12) Patent Application Publication
(10) Pub. No.: US 2026/0263299 A1
(43) Pub. Date: Sep. 10, 2026

(54) Patient Support Apparatus For Removably Securing An Oxygen Bottle

(71) Applicant: STRYKER CORPORATION, Portage, MI (US)

(72) Inventors: Connor Feldpausch St. John, Kalamazoo, MI (US); William Dwight Childs, Plainwell, MI (US)

(73) Assignee: STRYKER CORPORATION, Portage, MI (US)

(21) Appl. No.: 19/497,722

(22) PCT Filed: Jan. 30, 2024
(86) PCT No.: PCT/US2024/013425

§ 371 Date: Dec. 29, 2025

Related U.S. Application Data
(60) Provisional application No. 63/530,322, filed on Aug. 2, 2023.

(51) Int. Cl. A61G 7/05; A61G 7/012

(52) U.S. Cl. CPC A61G 7/0503; A61G 7/012

(57) ABSTRACT

A patient support apparatus for use in removably securing an oxygen bottle is provided. The patient support apparatus includes a bottle holder assembly including a mount operatively attached to the intermediate frame for concurrent movement between the plurality of vertical configurations. The bottle holder assembly also includes a earner subassembly including a carrier supported for pivoting movement, a receptacle to receive an end of the oxygen bottle, and a linkage supporting the receptacle for movement relative to the carrier between a stowed position and a use position. The carrier subassembly is supported for pivoting movement relative to the mount between a plurality of carrier orientations including a stowed carrier orientation and one or more deployed earner orientations.

### CROSS-REFERENCE TO RELATED APPLICATION

The subject patent application claims priority to and all the benefits of United States Provisional Patent Application No. 63/530,322 filed on Aug. 2, 2023, the disclosure of which is hereby incorporated by reference in its entirety.

### BACKGROUND

Patient support apparatuses, such as hospital beds, stretchers, cots, tables, wheelchairs, and chairs are used to help caregivers facilitate care of patients in a health care setting. Conventional patient support apparatuses generally comprise a base and a patient support surface upon which the patient is supported. Often, these patient support apparatuses have one or more movable components, such as side rails that can be moved between raised and lowered positions, deck sections which articulate to adjust the patient support surface to support the patient between different patient support configurations, as well as lift mechanisms that adjust the height of the patient support surface.

For emergency situations, life support devices, such as an oxygen bottle, are generally secured to patient support apparatuses. The oxygen bottle is secured to the patient support apparatus for situations where a patient has breathing disorders or problems that necessitate the use of oxygen. With patient support apparatuses having lift mechanisms and being generally mobile, the oxygen bottle needs to be properly secured to the patient support apparatus during movement such that the oxygen bottle does not detach, fall off, or loosely bounce around on the patient support apparatus. Additionally, with the height of the patient support surface being adjustable, the oxygen bottle needs to be properly secured such that the oxygen bottle is not dragged along floor surfaces or obstruct movement. Furthermore, there exists a need to stow the assembly configured to receive the oxygen bottle such that, in instances where an oxygen bottle is not in use, the assembly does not inhibit transport or operation of the patient support apparatus.

Other types of conventional patient support apparatuses may secure the oxygen bottle to the patient support apparatus, but these types of designs are complicated to secure the oxygen bottle, are difficult to remove the oxygen bottle, and can result in decreased performance in response to an emergency situation.

Previous patient support apparatuses that secure oxygen bottles have left room for improvement in this area. Accordingly, there remains a need in the art to address one or more of the challenges outlined above.

### SUMMARY

The present disclosure provides a patient support apparatus for use in removably securing an oxygen bottle, including: a base; an intermediate frame supporting a patient support deck; a lift mechanism coupled between the intermediate frame and the base to move the intermediate frame relative to the base between a plurality of vertical configurations; a bottle holder assembly including: a mount operatively attached to the intermediate frame for concurrent movement between the plurality of vertical configurations, the mount defining a mount axis, and a carrier subassembly including: a carrier supported for pivoting movement about the mount axis; a receptacle defining an inlet to receive an end of the oxygen bottle along a receptacle axis; and a linkage supporting the receptacle for movement relative to the carrier between a stowed position defined with the receptacle axis disposed at a first angle relative to the mount axis, and a use position defined with the receptacle axis disposed at a second angle, smaller than the first angle, relative to the mount axis, wherein the carrier subassembly is supported for pivoting movement relative to the mount about the mount axis between a plurality of carrier orientations including: a stowed carrier orientation defined with the receptacle arranged adjacent to the intermediate frame and disposed in the stowed position, and one or more deployed carrier orientations defined with the receptacle spaced from the intermediate frame.

### BRIEF DESCRIPTION OF THE DRAWINGS

Advantages of the present disclosure will be readily appreciated as the same becomes better understood by reference to the following detailed description when considered in connection with the accompanying drawings.

FIG. 1 is perspective view of a patient support apparatus having a base, a litter with a patient support deck, a lift mechanism, side rails, and a bottle holder assembly.

FIG. 2 is an illustrative view of a control system of the patient support apparatus of FIG. 1.

FIG. 3A is a schematic left-side view of the patient support apparatus of FIG. 1, shown with a first side rail and a second side rail arranged in a raised position, and with the bottle holder assembly operatively attached to an intermediate frame.

FIG. 3B a schematic left-side view of the patient support apparatus of FIG. 3A, shown with the second side rail arranged in an intermediate position, and shown with the first side rail arranged in the raised position.

FIG. 3C a schematic left-side view of the patient support apparatus of FIG. 3A, shown with the second side rail arranged in a lowered position, and shown with the first side rail arranged in the raised position.

FIG. 4A is another schematic left-side view of the patient support apparatus of FIGS. 3A-3B, shown with two of the side rails removed for illustrative purposes but depicting the bottle holder assembly operatively attached to the intermediate frame, and with the lift mechanism supporting the litter in a raised configuration.

FIG. 4B is another schematic left-side view of the patient support apparatus of FIG. 4A, shown with the lift mechanism supporting the litter in a lowered configuration.

FIG. 5A is a perspective view of the intermediate frame, wherein a receptacle of the bottle holder assembly is disposed in a stowed position, and wherein a carrier subassembly of the bottle holder assembly is disposed in a stowed carrier orientation.

FIG. 5B is a top-down view of the intermediate frame, wherein the receptacle of the bottle holder assembly is disposed in the stowed position, and wherein the carrier subassembly of the bottle holder assembly is disposed in the stowed carrier orientation.

FIG. 6A is a perspective view of the intermediate frame, wherein the receptacle of the bottle holder assembly is disposed in the stowed position, and wherein the carrier subassembly of the bottle holder assembly is disposed in a longitudinal deployed carrier orientation.

FIG. 6B is a top-down view of the intermediate frame, wherein the receptacle of the bottle holder assembly is disposed in the stowed position, and wherein the carrier subassembly of the bottle holder assembly is disposed in the longitudinal deployed carrier orientation.

FIG. 7A is a perspective view of the intermediate frame, wherein the receptacle of the bottle holder assembly is disposed in a use position, and wherein the carrier subassembly of the bottle holder assembly is disposed in the longitudinal deployed carrier orientation.

FIG. 7B is a top-down view of the intermediate frame, wherein the receptacle of the bottle holder assembly is disposed in the use position, and wherein the carrier subassembly of the bottle holder assembly is disposed in the longitudinal deployed carrier orientation.

FIG. 8A is a perspective view of the intermediate frame, wherein the receptacle of the bottle holder assembly is disposed in the use position, and wherein the carrier subassembly of the bottle holder assembly is disposed in a lateral deployed carrier orientation.

FIG. 8B is a top-down view of the intermediate frame, wherein the receptacle of the bottle holder assembly is disposed in the use position, and wherein the carrier subassembly of the bottle holder assembly is disposed in the lateral deployed carrier orientation.

FIG. 9A is a perspective view of the bottle holder assembly, wherein the receptacle of the bottle holder assembly is disposed in the stowed position.

FIG. 9B is a perspective view of the bottle holder assembly, wherein the receptacle of the bottle holder assembly is disposed in the use position, and wherein the receptacle receives an oxygen bottle of a first diameter.

FIG. 9C is a perspective view of the bottle holder assembly, wherein the receptacle of the bottle holder assembly is disposed in the use position, and wherein the receptacle receives an oxygen bottle of a second diameter.

FIG. 10 is a partial, exploded perspective view of the bottle holder assembly.

### DETAILED DESCRIPTION

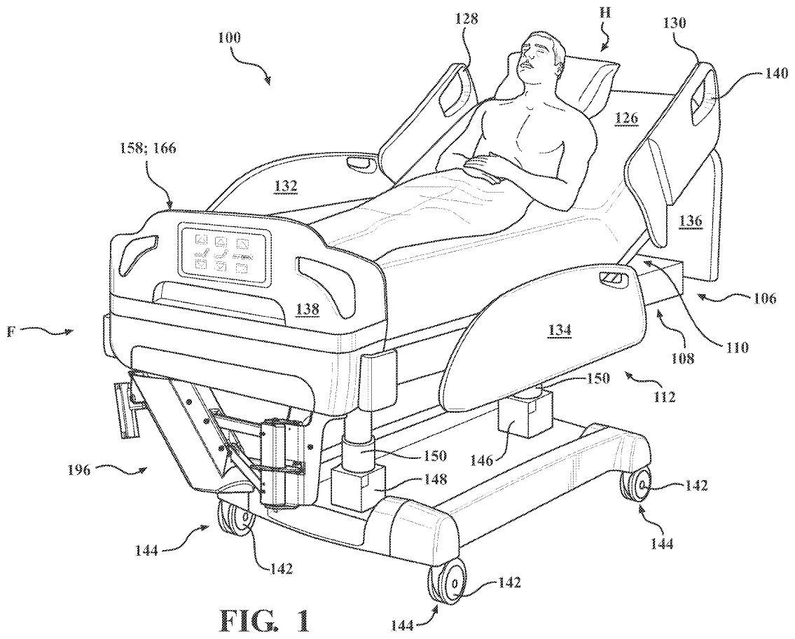

Referring to FIG. 1, a patient support apparatus 100 is shown for supporting a patient in a heath care setting. The patient support apparatus 100 illustrated throughout the drawings is realized as a hospital bed. In other versions, however, the patient support apparatus 100 may be a stretcher, a cot, a table, a wheelchair, a chair, or a similar apparatus utilized in the care of a patient.

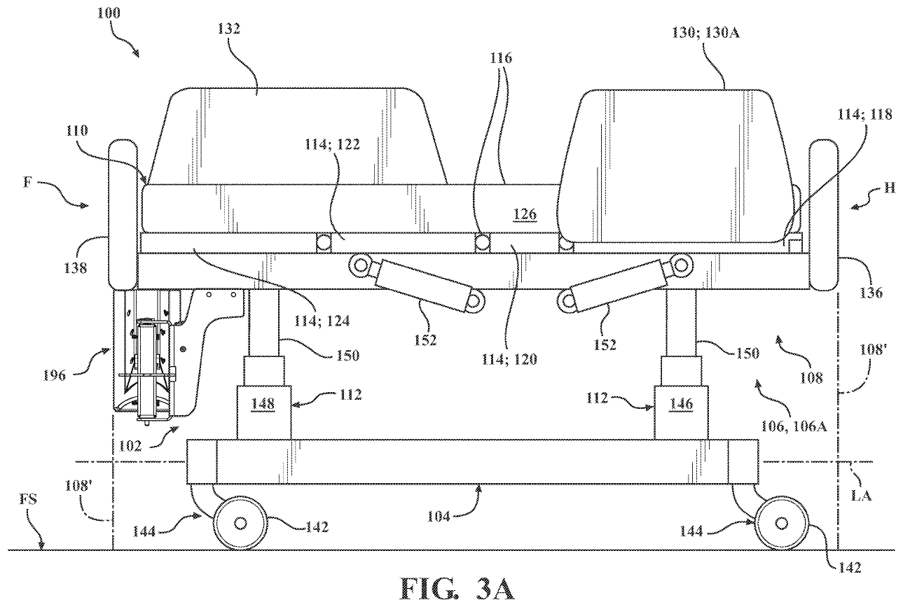

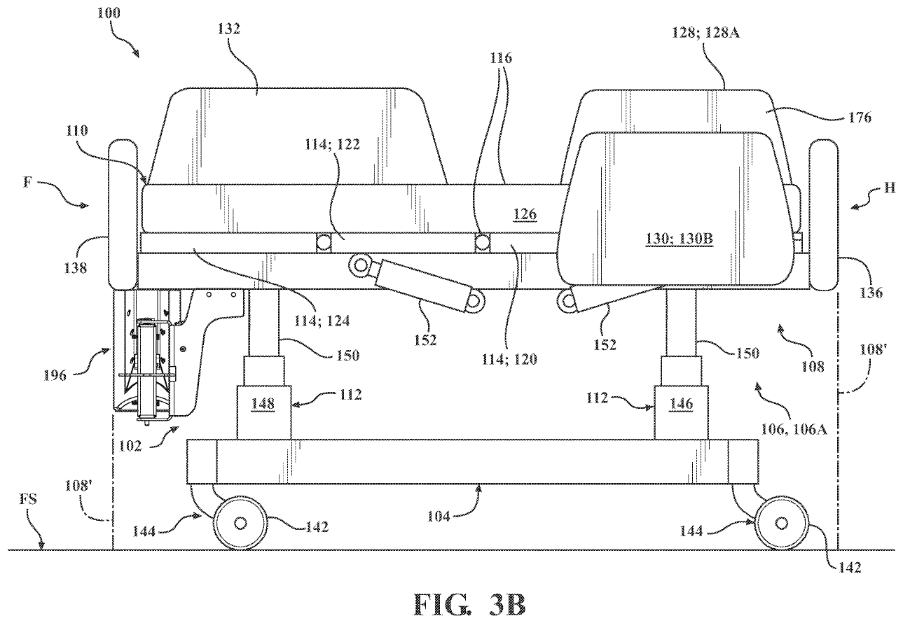

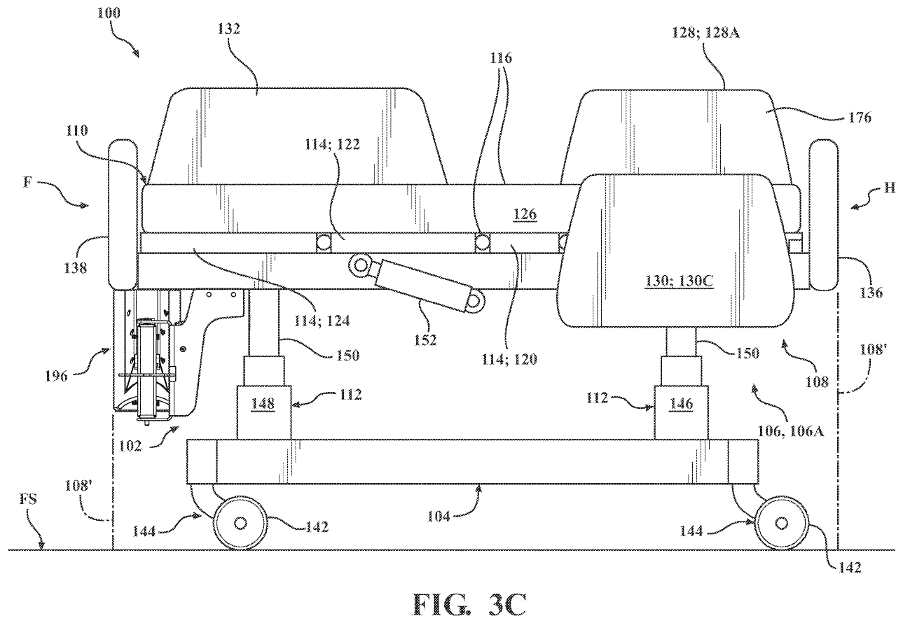

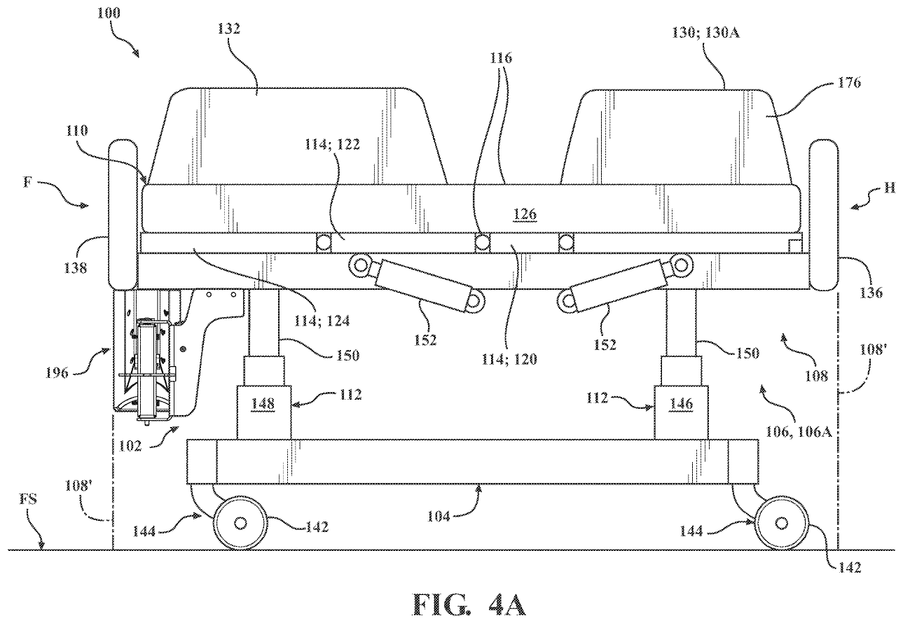

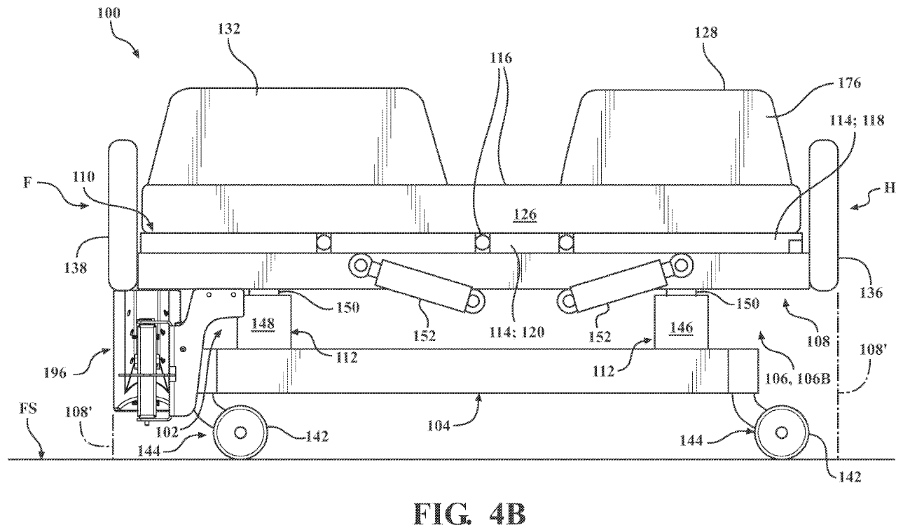

A support structure 102 provides support for the patient. In the representative version illustrated herein, the support structure 102 generally comprises a base 104 and a litter 106. Here, the litter 106 includes an intermediate frame 108 and a patient support deck 110 spaced above the base 104. The intermediate 108 frame defines a foot end F and a head end H. Additionally, as shown in FIGS. 3A-3B, the intermediate frame 108 defines an intermediate frame footprint 108′ projected downward on a floor surface FS. The base 104 defines a longitudinal axis LA from a head end to a foot end. The intermediate frame 108 is spaced above the base 104. As is described in greater detail below, a lift mechanism 112 is interposed between the base 104 and the intermediate frame 108 to facilitate moving the litter 106 relative to the base 104 between a plurality of vertical configurations, including without limitation one or more raised configurations 106A (see FIGS. 3A-4A), lowered configurations 106B (see FIG. 4B), and/or inclined configurations such as a Trendelenburg configuration (not shown).

The patient support deck 110 has at least one deck section 114 arranged for movement relative to the intermediate frame 108 between a plurality of section positions (not shown in detail). The deck sections 114 of the patient support deck 110 provide a patient support surface 116 upon which the patient is supported. More specifically, in the representative version of the patient support apparatus 100 illustrated herein, the patient support deck 110 has four deck sections 114 which cooperate to define the patient support surface 116: a back section 118, a seat section 120, a leg section 122, and a foot section 124 (see FIGS. 3A-6). In the representative version illustrated herein, the seat section 120 is fixed to the intermediate frame 108 and is not arranged for movement relative thereto. However, it will be appreciated that the seat section 120 could be movable relative to other deck sections 114 in some versions. Conversely, the back section 118 and the leg section 122 are arranged for independent movement relative to each other and to the intermediate frame 108, as described in greater detail below, and the foot section 124 is arranged to move partially concurrently with the leg section 122. Other configurations are contemplated, and it will be appreciated that different arrangements of deck sections 114 are contemplated by the present disclosure. By way of non-limiting example, the patient support deck 110 could be configured without a discrete seat section 120 in some versions. Furthermore, while the representative version of the litter 106 illustrated herein employs the intermediate frame 108 to support the deck sections 114 of the patient support deck 110 for movement relative to the base 104 via the lift mechanism 112, it will be appreciated that various types of litters 106, with or without discrete intermediate frames 108 and/or with a differently-configured lift mechanism 112, are contemplated by the present disclosure.

A mattress 126 is disposed on the patient support deck 110 during use. The mattress 126 comprises or otherwise defines the patient support surface 116 upon which the patient is supported, but it will be appreciated that its shape is defined based on the arrangement of the patient support deck 110. Here too, it will be appreciated that the patient support deck 110 itself would define the patient support surface 116 during operation of some versions of the patient support apparatus 100 without the mattress 126. Put differently, the mattress 126 may be omitted in certain versions, such that the patient can rest directly on the patient support surface 116 defined by the deck sections 114 of the patient support deck 110. The base 104, the litter 106, the intermediate frame 108, and the patient support deck 110 each have a head end and a foot end corresponding to designated placement of the patient's head and feet on the patient support apparatus 100. It will be appreciated that the specific configuration of the support structure 102 may take on any known or conventional design, and is not limited to that specifically illustrated and described herein. Other configurations are contemplated.

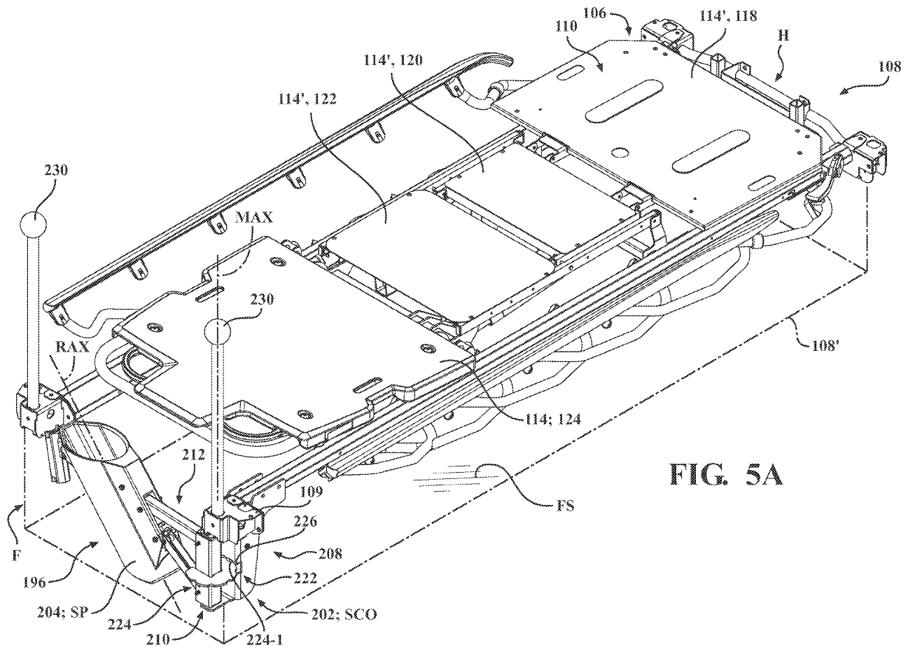

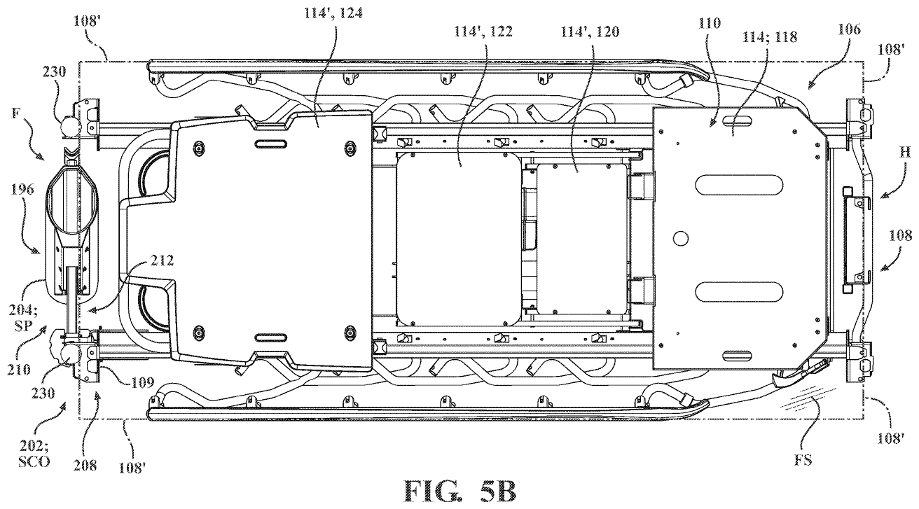

Side rails 128, 130, 132, 134 are coupled to the support structure 102 via mounts and are supported for movement relative to the intermediate frame 108 (and, thus, relative to the base 104). A first side rail 128 is positioned at a right head end of the litter 106. A second side rail 130 is positioned at a left head end of litter 106. A third side rail 132 is positioned at a right foot end of the litter 106. A fourth side rail 134 is positioned at a left foot end of the litter 106. As shown in FIG. 5, one or more of the side rails may be coupled to one or mounts via linkages and may be movable between a plurality of side rail positions, including a raised position 128A, 130A in which they block ingress and egress into and out of the patient support apparatus 100 (see FIG. 3A), one or more intermediate positions 128B, 130B (see FIG. 3B), and a lowered position 128C, 130C (see FIG. 3C) in which they are not an obstacle to such ingress and egress across the periphery P of the patient support surface 116. It will be appreciated that there may be fewer side rails for certain versions, such as where the patient support apparatus 100 is realized as a stretcher or a cot. Similarly, it will be appreciated that side rails may be attached to any suitable component or structure of the patient support apparatus 100, and that their respective mount 125 and/or linkage 139 may be configured in various ways. In some versions, the side rails 128, 130, 132, 134 or other portions of the patient support apparatus 100 may be similar to as is described in U.S. Patent Application Publication No. US 2021/0338504 A1, entitled “Side Rail Assembly For A Patient Support Apparatus,” the disclosure of which is hereby incorporated by reference in its entirety. Other configurations are contemplated. In the representative version illustrated herein, the first and second side rails 128, 130 are coupled to the back section 118 of the patient support deck 110 and move concurrently therewith. In FIGS. 4A-4B, which each depict left-side views of the patient support apparatus 100, the second and fourth side rails 130, 134 are omitted for illustrative purposes.

As shown in FIGS. 1 and 3A-4B, a headboard 136 and a footboard 138 are coupled to respective mounts of the intermediate frame 108 of the litter 106. However, it will be appreciated that the headboard 136 and/or footboard 138 may be coupled to other locations on the patient support apparatus 100, such as the base 104, or may be omitted in certain versions. One or more caregiver interfaces 140, such as handles, are shown in FIG. 1 as being integrated into the first and second side rails 128, 130 to facilitate movement of the patient support apparatus 100 over floor surfaces FS. Additional caregiver interfaces 140 may be integrated into the headboard 136, the footboard 138, and/or other components of the patient support apparatus 100, such as the third and/or fourth side rails 132, 134, the intermediate frame 108, and the like. The caregiver interfaces 140 are shaped so as to be grasped by a caregiver as a way to position or otherwise manipulate the patient support apparatus 100 for movement. It will be appreciated that the caregiver interfaces 140 could be integrated with or operatively attached to any suitable portion of the patient support apparatus 100, or may be omitted in certain versions.

Wheels 142 are coupled to the base 104 to facilitate transportation over floor surfaces FS. The wheels 142 are arranged in each of four quadrants of the base 104, adjacent to corners of the base 104. In the version shown in FIG. 1, the wheels 142 are caster wheels that are able to rotate and swivel relative to the support structure 102 during transport. Here, each of the wheels 142 forms part of a caster assembly 144 mounted to the base 104. In the illustrated version, the patient support apparatus 100 includes a brake assembly 153 operatively attached to one or more of the wheels 142 and being operable between a braked state 153B to inhibit movement of the base 104 about floor surfaces FS, and an unbraked state 153U to permit movement of the base 104 about floor surfaces FS. In some versions, the brake assembly 153 includes a brake lever 155 (e.g., a foot pedal) operatively attached to the base 104 and arranged for user engagement to operate the brake assembly 153 between the braked state 153B and the unbraked state 153U. In some versions, the brake assembly 153 may be similar to as is disclosed in U.S. Pat. No. 10,806,653, entitled “Patient Transport Apparatus With Electro-Mechanical Braking System,” and/or International Patent Application Publication No. WO 2021/138176 A1, entitled “Patient Transport Apparatus With Electro-Mechanical Braking System,” the disclosures of each of which are hereby incorporated by reference in their entirety. Other configurations are contemplated.

It should be understood that various configurations of the caster assemblies 144 are contemplated. In addition, in some versions, the wheels 142 are not caster wheels. Moreover, it will be appreciated that the wheels 142 may be non-steerable, steerable, non-powered, powered, or combinations thereof. While the representative version of the patient support apparatus 100 illustrated herein employs four wheels 142, additional wheels are also contemplated. For example, the patient support apparatus 100 may comprise four non-powered, non-steerable wheels, along with one or more additional powered wheels. In some cases, the patient support apparatus may not include any wheels. In other versions, one or more auxiliary wheels (powered or non-powered), which are movable between stowed positions and deployed positions, may be coupled to the support structure 102. In some cases, when auxiliary wheels are located between caster assemblies 144 and contact the floor surface FS in the deployed position, they cause two of the caster assemblies 144 to be lifted off the floor surface FS, thereby shortening a wheel base of the patient support apparatus 100. A fifth wheel may also be arranged substantially in a center of the base 104.

As noted above, the patient support apparatus 100 employs the lift mechanism 112 to lift and lower the litter 106 relative to the base 104 which, in turn, moves the intermediate frame 108 together with the patient support deck 110 between various vertical configurations, such as to the raised vertical configuration 106A depicted in FIGS. 3A-4A, the lowered vertical configuration 106B depicted in FIG. 4B, or to any desired vertical configuration therebetween including various inclined configurations. To this end, the lift mechanism 112 may include a head end lift member 146 and a foot end lift member 148 which are each arranged to facilitate movement of the litter 106 with respect to the base 104 using one or more lift actuators 150. The lift actuators 150 may be realized as linear actuators, rotary actuators, or other types of actuators, and may be electrically operated and/or may be hydraulic. It is contemplated that, in some configurations, only one lift member and one associated lift actuator may be employed, e.g., to raise only one end of the litter 106, or one central lift actuator to raise and lower the litter 106. The construction of the lift mechanism 112, the head end lift member 146, and/or the foot end lift member 148 may take on any known or conventional design, and is not limited to that specifically illustrated. By way of non-limiting example, the lift mechanism 112 could comprise a “scissor” linkage arranged between the base 104 and the litter 106 with one or more actuators configured to facilitate vertical movement of the patient support deck 110. In some versions, the lift mechanism 112 may be similar to as is described in U.S. Pat. No. 10,172,753, entitled “Patient Support Lift Assembly,” the disclosure of which is hereby incorporated by reference in its entirety. Other configurations are contemplated.

As noted above, the patient support deck 110 is operatively attached to the intermediate frame 108 (e.g., as depicted in FIGS. 1 and 3A-6), with one or more of the deck sections 114 arranged for movement between a first section position and a second section position. To this end, one or more deck actuators 152 are interposed between the deck section 114 and the intermediate frame 108 to move the deck section 114. In the representative versions illustrated herein, the deck actuator 152 is realized as a linear actuator disposed in force-translating relationship between the deck section 114 and the intermediate frame 108. More specifically, one deck actuator 152 is provided between the intermediate frame 108 and the back section 118, and another deck actuator 152 is provided between the intermediate frame 108 and the leg section 122, and each of the deck actuators 152 is arranged for independent movement to position the respective deck sections 114 to adjust the shape of the patient support surface 116 between a plurality of patient support configurations (for example, a flat configuration, a raised fowler configuration, a seated configuration, etc.). The deck actuator 152 coupled to the back section 118 is configured to move the back section 118 between the first section position, the second section position, as well as to additional section positions between the first and second section positions and/or to section positions beyond the second section position.

Those having ordinary skill in the art will appreciate that the patient support apparatus 100 could employ any suitable number of deck actuators 152, of any suitable type or configuration sufficient to effect selective movement of one or more of the deck sections 114 relative to the litter 106 or other components of the support structure 102. By way of non-limiting example, the deck actuator 152 could be a linear actuator or one or more rotary actuators driven electronically and/or hydraulically, and/or controlled or driven in any suitable way. Moreover, the deck actuator 152 could be mounted, secured, coupled, or otherwise operatively attached to the intermediate frame 108 and to the deck section 114, either directly or indirectly, in any suitable way. In addition, one or more of the deck actuators 152 could be omitted for certain applications.

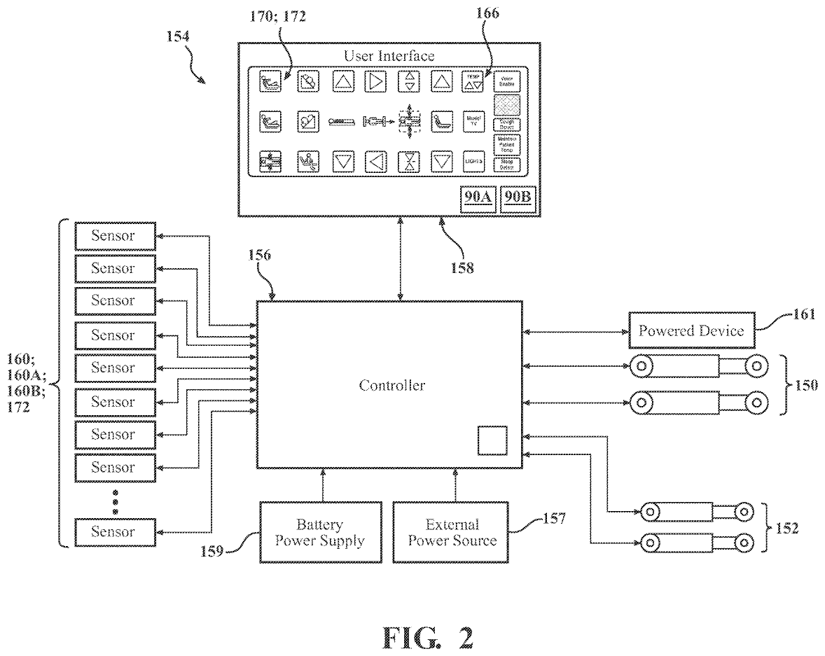

The patient support apparatus 100 employs a control system, generally indicated at 154, to effect operation of various functions of the patient support apparatus 100, as described in greater detail below. To this end, and as is best shown schematically in FIG. 2, the control system 154 generally includes a controller 156 disposed in communication with one or more user interfaces 158 adapted for use by the patient and/or the caregiver to facilitate operation of one or more functions of the patient support apparatus 100. In certain versions, the controller 156 is also disposed in communication with the lift actuators 150, the deck actuators 152, a sensor system 160, one or more local alarms 162, one or more charging interfaces 164, and/or a communication interface 166 for communicating with a remote device 168. Each of these components will be described in greater detail below.

As noted above, the controller 156 is best depicted schematically FIG. 2, and has been omitted from certain drawings for the purposes of clarity and consistency. It will be appreciated that the controller 156 and/or the control system 154 can be configured or otherwise arranged in a number of different ways. The controller 156 may have one or more microprocessors for processing instructions or for processing an algorithm stored in memory to control operation of the actuators 150, 152, generation or interpretation of signals and/or data (e.g., data from sensors, the sensor system 160, and the like), communication with the user interfaces 158 and/or remote devices 168, performance of one or more functions of powered devices 161, and the like. Additionally or alternatively, the controller 156 may comprise one or more microcontrollers, field programmable gate arrays, systems on a chip, discrete circuitry, and/or other suitable hardware, software, or firmware that is capable of carrying out the various functions and operations described herein. The controller 156 may be carried on-board the patient support apparatus 100, such as on the base 104 or the litter 106, or may be remotely located. The controller 156 may comprise one or more subcontrollers configured to control all of the actuators 150, 152 and/or user interfaces 158 or one or more subcontrollers for each actuator 150, 152 and/or user interface 158 (or other component of the patient support apparatus 100). The controller 156 may communicate with the actuators 150, 152, the user interfaces 158, and or other components of the control system 154 via wired or wireless connections. Power to the actuators 150, 152, other powered devices, and/or the controller 156 may be provided by an external power source 157 and/or a battery back-up power supply 159. The external power source 157 and/or the battery back-up power supply 159 may provide power to one or more powered devices 161, actuators 150, 152, user interfaces 158, and/or charging interfaces 164. The battery back-up power supply 159 may include one or more chargers. For instance, a bed charger may be provided in electrical communication with the battery back-up power supply 159. The bed charger may have a tether for attaching to a main power source and/or the external power source 157 to charge the battery back-up power supply 159.

In the representative version illustrated in FIGS. 1 and 2, the patient support apparatus 100 comprises a plurality of user interfaces 158 which may be accessible by the patient, the caregiver, or by both the caregiver and the patient. Each user interface 158 of the patient support apparatus 100 generally comprises an input device 170 configured to generate an input signal in response to activation by a user which, in turn, is communicated to the controller 156. The controller 156, in turn, is responsive to the input signal and can control or otherwise carry out one or more functions of the patient support apparatus 100 in response to receiving the input signal. Put differently, the controller 156 is configured to perform a function of the patient support apparatus 100 in response to receiving the input from the input device 170. By way of non-limiting example, the input device 170 could be realized as a “lift bed” button, activation of which causes the controller 156 to drive the lift1 actuators 150 to move the intermediate frame 108 of the litter 106 from the maximum lowered configuration 106B (see FIG. 4B) vertically away from the base 104 towards the raised configuration 106A (see FIG. 4A). In some versions, one or more of the user interfaces 158 may also employ an output device 172, such as a screen, one or more audible and/or visual indicators (e.g., speakers, beepers, light emitting diodes LEDs, and the like), to communicate information to the user (e.g., to the caregiver). In some versions, the user interface 158 may be realized as a touchscreen interface that serves as both an input device 170 and an output device 172. In some versions, the controller 156 may be configured to facilitate navigation of visual content of the user interface 158 (e.g., realized as a graphical user interface GUI) in response to receiving the input signal from the input device 170. Thus, it will be appreciated that the user interface 158 could be configured in a number of different ways sufficient to generate the input signal. Moreover, it will be appreciated that the user interfaces 158 could be of a number of different styles, shapes, configurations, and the like. By way of non-limiting example, one or more of the user interfaces 158 may comprise buttons, indicators, screens, graphical user interfaces, and the like. Other configurations are contemplated.

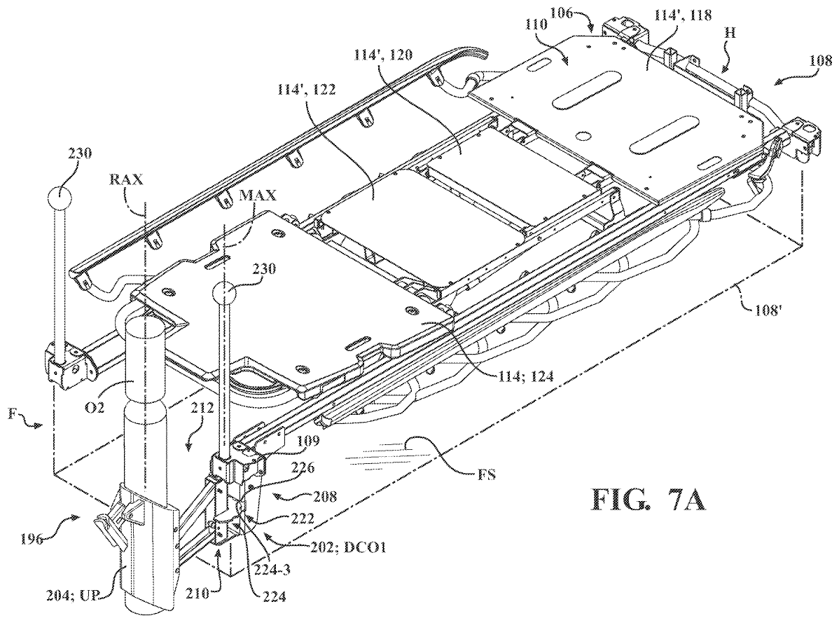

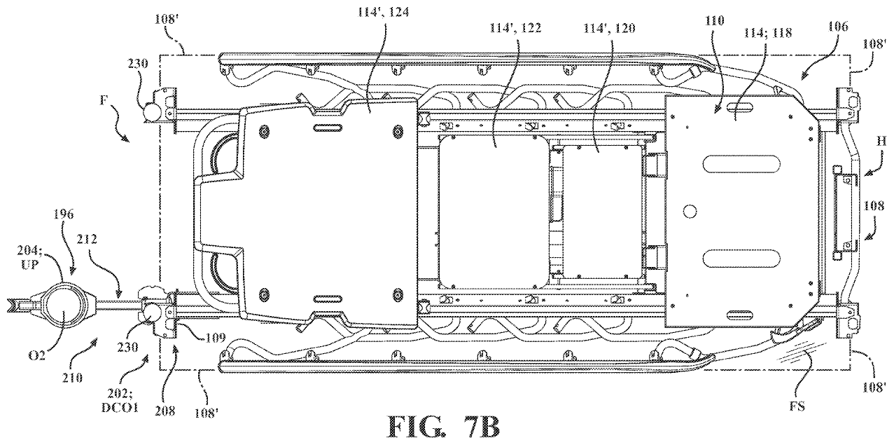

Referring to FIG. 1, the patient support apparatus 100 includes a bottle holder assembly 196. The bottle holder assembly 196 may hold a bottle or a tank for treating a patient resting on the patient support apparatus 100. In the instances shown herein, the bottle holder assembly 196 holds an oxygen bottle O2 providing oxygen to a patient resting on the patient support apparatus 100, as shown in FIG. 7A.

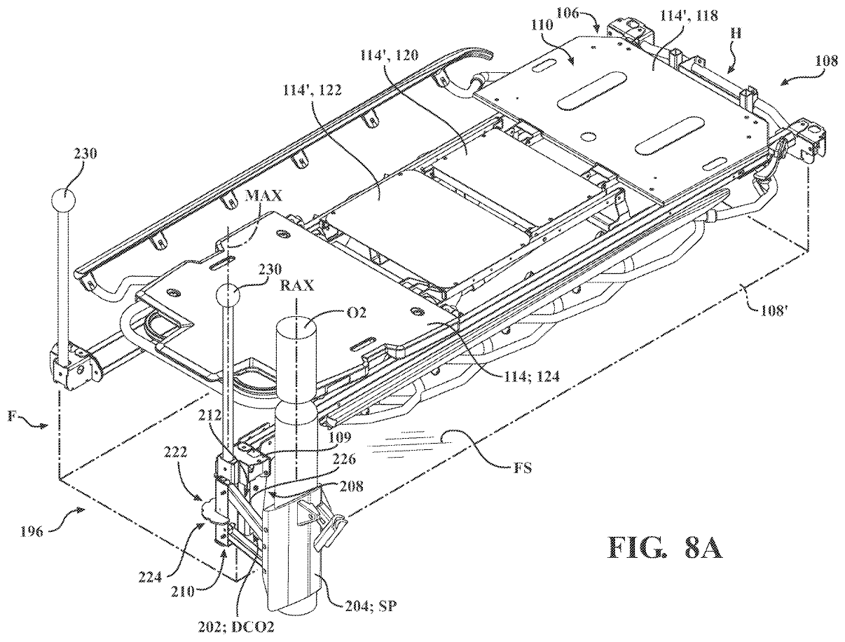

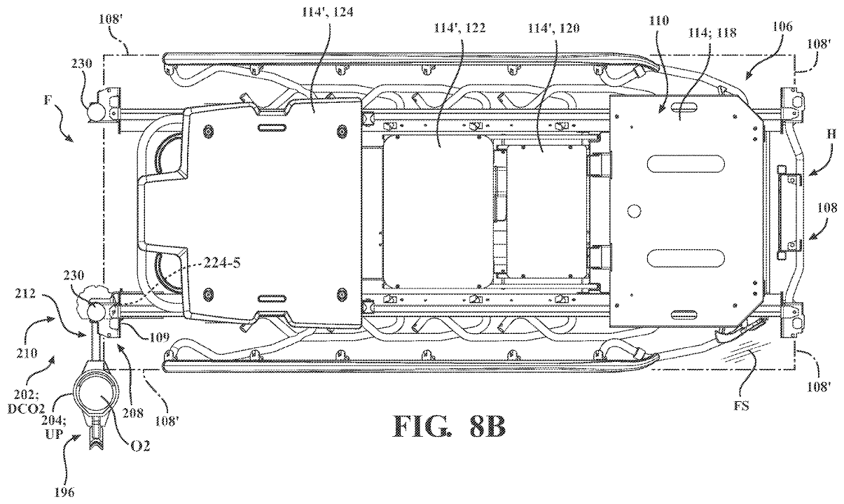

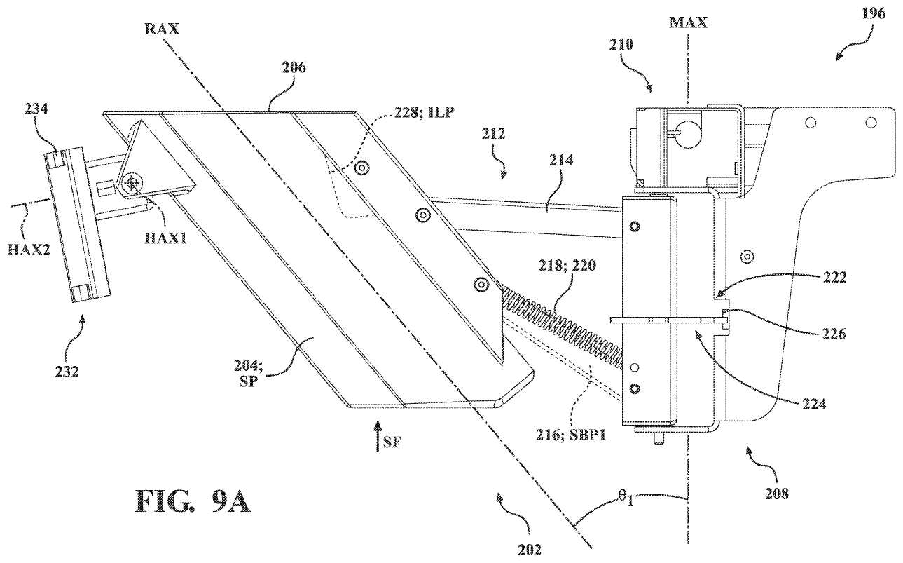

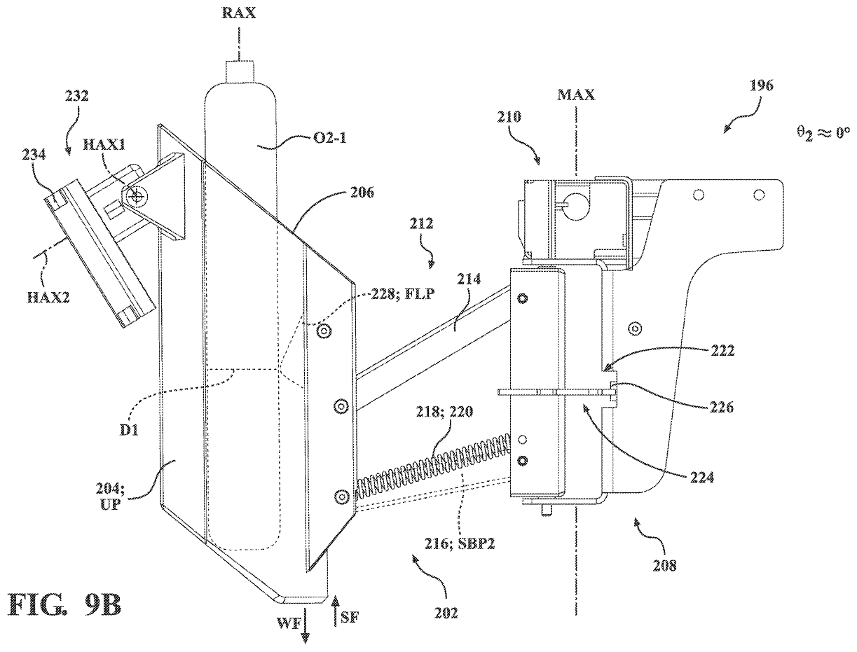

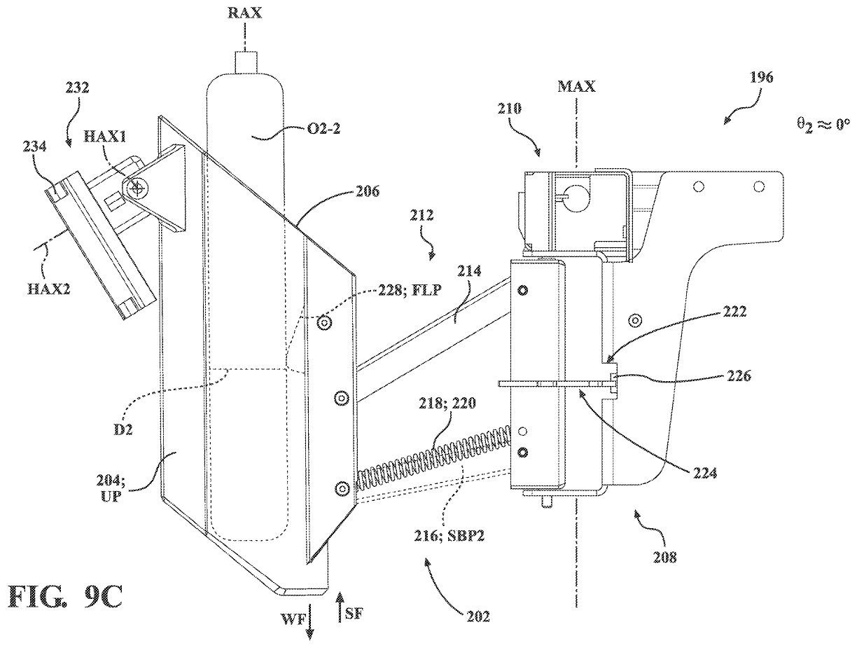

Referring to FIGS. 9A-9C, the bottle holder assembly 196 includes carrier subassembly 202 including a receptacle 204 defining an inlet 206 to receive an end of a bottle or an end of a tank along a receptacle axis RAX. For example, referring to FIGS. 5A and 5B, the receptacle 204 is shown in a stowed position SP (to be described in greater detail below), where the bottle holder assembly 196 does not hold a bottle or a tank. Referring to FIG. 7A-8B, the receptacle 204 is shown in a use position UP (to be described in greater detail below) holding an oxygen bottle O2.

The bottle holder assembly 196 includes a mount 208 operatively attached to the intermediate frame 108. The mount 208 may be operatively attached to the intermediate frame 108 such that the mount 208 moves concurrently with the intermediate frame 108 when the lift mechanism 112 moves the intermediate frame 108 between the plurality of vertical configurations. Additionally, as shown in FIG. 9A-9C, the mount 208 defines a mount axis MAX.

As shown in FIGS. 5A-8C, the mount 208 is coupled to a corner 109 of the intermediate frame and the mount axis MAX is arranged adjacent to the corner 109. It should be noted that the mount 208 and other components of the bottle holder assembly 196 may be operatively attached to any part of the patient support apparatus 100. For example, the mount 208 may be operatively attached to any other corner of the intermediate frame 108, such as a corner near the head end H of the intermediate frame 108. As another example, the mount 208 may be operatively attached to the base 104 of the patient support apparatus 100.

The carrier subassembly 202 may include a carrier 210 for supporting the receptacle 204 for movement relative to the carrier 210 between a stowed position SP and a use position UP.

As shown in FIG. 9A, the stowed position SP is defined with the receptacle axis RAX being disposed at a first angle θ₁ relative to the mount axis MAX. In the instance of FIG. 9A, the first angle θ₁ is approximately 45 degrees. In other instances, the receptacle axis RAX may be disposed at any suitable angle relative to the mount axis MAX in the stowed position SP. For example, the receptacle axis RAX may be disposed at any suitable first angle θ₁ such that the receptacle 204 may be disposed within the footprint 108′ of the intermediate frame 108 (to be explained in greater detail below).

As shown in FIGS. 9B and 9C, the use position is defined with the receptacle axis RAX being disposed at a second angle θ₂, smaller than the first angle θ₁, relative to the mount axis MAX. In the instance of FIGS. 9B and 9C, the receptacle axis RAX is approximately parallel to the mount axis MAX. As such, the second angle θ₂ is approximately 0 degrees. In other instances, the receptacle axis RAX may be disposed at any suitable second angle θ₂ relative to the mount axis MAX in the use position UP, with the second angle θ₂ being smaller than the first angle θ₁. For example, a weight of the oxygen bottle O2 may urge the receptacle 204 toward the use position UP (to be described in greater detail below) and, depending on the weight of the oxygen bottle O2, the second angle θ₂ may vary.

The carrier subassembly 202 may include a linkage 212 for supporting the receptacle 204 for movement relative to the carrier 210 between a stowed position SP and a use position UP. Referring to FIGS. 9A-9C, the linkage 212 includes a first bar 214 pivotably coupled to the receptacle 204 and to the carrier 210, and a second bar 216 spaced from the first bar 214 and pivotably coupled to the receptacle 204 and to the carrier 210. As shown in FIGS. 9A-9C, the second bar 216 is supported for pivoting movement between a first position SBP1 supporting the receptacle 204 in the stowed position SP, and a second position SBP2 supporting the receptacle 204 in the use position UP. Specifically, in FIG. 9A, the second bar 216 is disposed in the first position SBP1 and the receptacle 204 is in the stowed position SP. In FIGS. 9B and 9C, the second bar 216 is disposed in the second position SBP2 and the receptacle 204 is in the use position UP.

Additionally, the carrier subassembly 202 may include a biasing mechanism 218, shown in FIGS. 9A-9C, configured to urge the receptacle 204 toward the stowed position SP. The biasing mechanism 218 is shown in FIGS. 9A-9C as including a spring 220 disposed adjacent to the second bar 216 of the linkage 212. As shown in FIGS. 9A-9C, the spring 220 is arranged to apply a spring force SF to urge the second bar 216 toward the first position SBP1 to dispose the receptacle 204 in the stowed position SP. In other instances, the biasing mechanism 218 may be any other biasing mechanism suitable for urging the receptacle 204 toward the stowed position SP and the biasing mechanism 218 may be disposed in any other component of the bottle holder assembly 196. For instance, the biasing mechanism 218 may be a weight disposed adjacent to the inlet 206 the receptacle 204 that biases the receptacle 204 toward the stowed position SP.

Furthermore, as shown in FIGS. 9B and 9C, a weight of an oxygen bottle O2 may dispose the receptacle 204 in the use position UP upon being received by the inlet 206. In such an instance, the weight of the oxygen bottle O2 may provide a weight force WF opposing the spring force SF provided by the biasing mechanism 218. As shown in FIGS. 9B and 9C, the weight force WF provided by the oxygen bottle O2 overcomes the spring force SF to dispose the receptacle 204 in the use position UP.

The carrier subassembly 202 is supported for pivoting movement relative to the mount 208 about the mount axis MAX. Additionally, the carrier subassembly 202 includes a carrier 210, the carrier 210 being supported for pivoting movement about the mount axis MA, with the carrier subassembly 202 and the carrier 210 being supported for pivoting movement relative to the corner 109 of the intermediate frame 108. The pivoting movement of the carrier subassembly 202 and the carrier 210 relative to the corner 109 is shown in FIGS. 5A-8B.

More particularly, the carrier subassembly 202 is supported for pivoting movement relative to the mount 208 about the mount axis MAX between a plurality of carrier orientations. Several carrier orientations are shown in FIGS. 5A-8B. It should be noted that, in other instances, the carrier subassembly 202 may be supported for pivoting movement between any suitable number of carrier orientations.

The plurality of carrier orientations includes a stowed carrier orientation SCO, which is shown in FIGS. 5A and 5B. As shown in FIG. 5A, the stowed carrier orientation SCO is defined with the receptacle 204 arranged adjacent to the intermediate frame 108 and disposed in the stowed position SP. Additionally, as shown in FIG. 5B, the receptacle 204 is disposed at least partially within the intermediate frame footprint 108′ when the carrier subassembly is in the stowed carrier orientation SP.

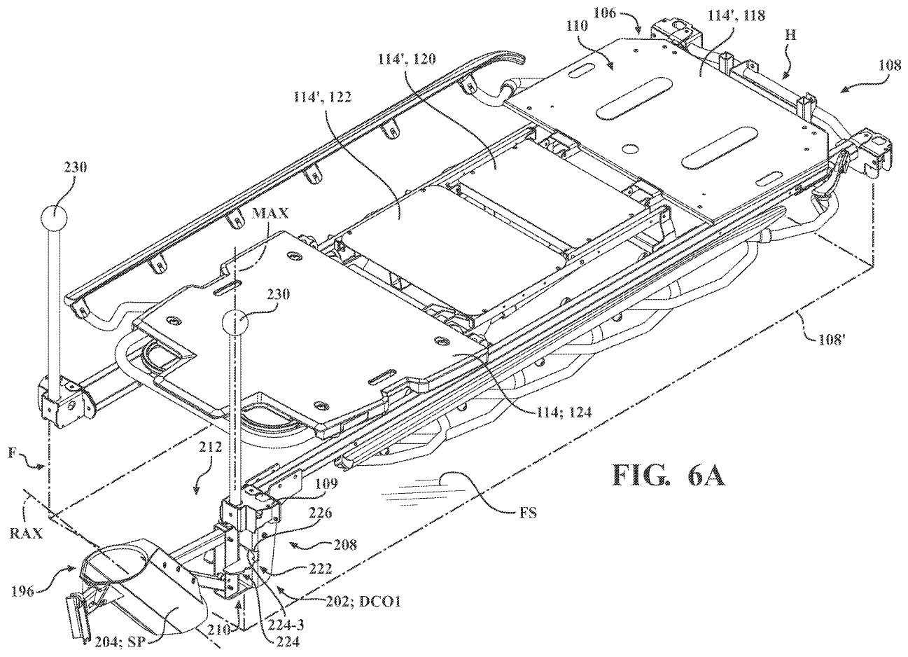

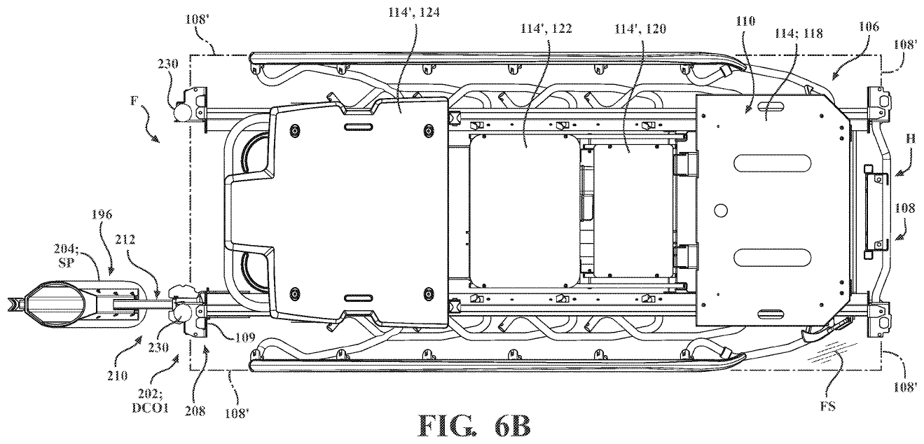

The plurality of carrier orientations also includes one or more deployed carrier orientations DCO. The one or more deployed carrier orientations DCO are defined with the receptacle 204 spaced from the intermediate frame 108. In the one or more deployed carrier orientations DCO, the receptacle 204 may be in either the stowed position SP or the use position UP. A longitudinal deployed carrier orientation DCO1 is shown in FIGS. 6A-7B. In the instance of FIGS. 6A and 6B, the carrier subassembly 202 is disposed in the longitudinal deployed carrier orientation DCO1 with the receptacle axis RAX spaced longitudinally from the foot end F of the intermediate frame 108 and the receptacle 204 is disposed in the stowed position SP. In the instance of FIGS. 7A and 7B, the carrier subassembly 202 is disposed in the longitudinal deployed carrier orientation DCO1 with the receptacle axis RAX spaced longitudinally from the foot end F of the intermediate frame 108 and the receptacle 204 is disposed in the use position UP supporting the oxygen bottle O2 along the receptacle axis RAX. Additionally, as shown in FIGS. 6B and 7B, the receptacle 204 is disposed at least partially within the intermediate frame footprint 108′ when the carrier subassembly is in the stowed carrier orientation SP. A lateral deployed carrier orientation DCO2 is shown in FIGS. 8A and 8B. In the instance of FIGS. 8A and 8B, the carrier subassembly 202 is disposed in the lateral deployed carrier orientation DCO2 with the receptacle axis RAX spaced laterally from the foot end F of the intermediate frame 108 and the receptacle 204 is disposed in the use position UP.

Referring to FIG. 5A, the carrier subassembly 202 may include a detent mechanism 222 defining a plurality of detents 224 arranged about the mount axis MAX, and a plunger 226 arranged to engage each of the plurality of detents 224 to maintain the carrier subassembly 202 in a respective carrier orientation. The detent mechanism 222, plunger 226, and plurality of detents 224 may also be seen in FIGS. 9A-9C. As shown in FIG. 5A, when the plunger 226 engages the first detent 224-1, the carrier subassembly 202 is disposed in the stowed carrier orientation SCO. As shown in FIG. 6A, when the plunger 226 engages the third detent 224-3, the carrier subassembly 202 is disposed in the longitudinal deployed carrier orientation DCO1. As shown in FIGS. 8A and 8B, when the plunger 226 engages the fifth detent 224-5, the carrier subassembly 202 is disposed in the lateral deployed carrier orientation DCO2. It should be noted that the detent mechanism 222 may include any suitable number of detents 224. For example, the detent mechanism 222 may include ten detents 224, each corresponding to a carrier orientation.

As previously stated, the receptacle 204 defining the inlet 206 receives an end of a bottle or an end of a tank along a receptacle axis RAX. Referring to FIGS. 9A-9C, a biasing lever 228 may be coupled to the receptacle 204 and supported for movement between an initial lever position ILP shown in FIG. 9A, a first lever position FLP shown in FIG. 9B, and a second lever position SLP shown in FIG. 9C. In the instance of FIG. 9A, the biasing lever 228 is biased toward toward an initial lever position ILP. The biasing lever 228 may be biased toward the initial lever position ILP using any suitable means. For example, the biasing lever 228 may be coupled to a spring providing a spring force to bias the biasing lever 228 toward the initial lever position ILP. In the instance of FIG. 9B, a side of an oxygen bottle O2-1 of a first diameter D1 abuts the biasing lever 228 in the first lever position FLP. More particularly, the side of the oxygen bottle O2-1 of the first diameter D1 pivots the biasing lever 228 from the initial lever position ILP to the first lever position FLP. In the instance of FIG. 9B, a side of an oxygen bottle 02-2 of a second diameter D2 abuts the biasing lever 228 in the second lever position SLP. More particularly, the side of the oxygen bottle O2-2 of the second diameter D1 pivots the biasing lever 228 from the initial lever position ILP to the second lever position SLP. The biasing lever 228 may pivot between any number of lever positions to abut an oxygen bottle O2 of any suitable diameter.

As shown in FIGS. 5A-8B, the patient support apparatus 100 may also include a caregiver interface 230, which may be arranged to allow a caregiver to interface with the caregiver interface 230 to transport the patient support apparatus 100 to a desired location. The caregiver interface 230 may be operatively attached to any component of the patient support apparatus 100. In the instance of FIGS. 5A-8B, the caregiver interface 230 is operatively attached to the intermediate frame 108. Additionally, the caregiver interface 230 is operatively attached such that the caregiver interface 230 is adjacent to the bottle holder assembly 196 and spaced from the mount axis MAX. Additionally, the caregiver interface 230 may include any suitable structure. In the instance of FIGS. 5A-8B, the caregiver interface 230 includes a vertical post arranged parallel to and spaced from the mount axis MAX.

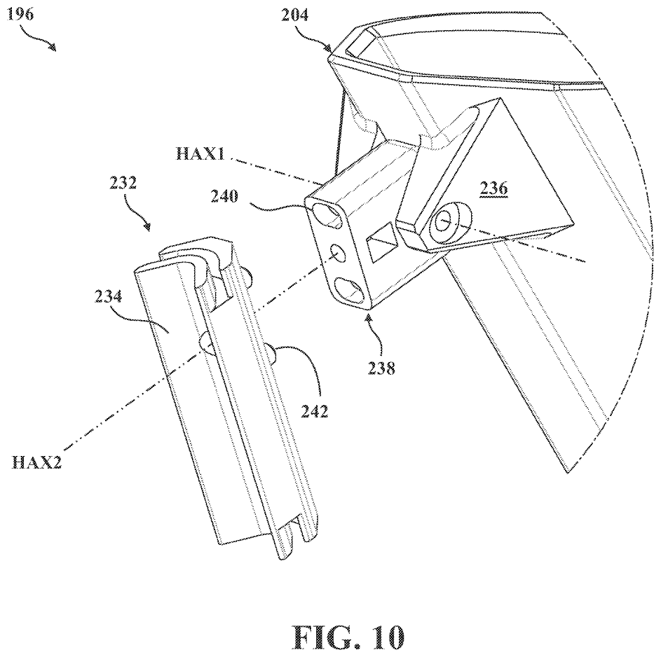

An intravenous pole holder 232 may be coupled to the receptacle 204, as shown in FIGS. 9A-10, arranged for receiving an intravenous pole (not shown, but generally known in the art). The intravenous pole holder 232 may include a receiver 234 for receiving an intravenous pole. The intravenous pole holder 232 may be arranged for receiving and securing an intravenous pole, even when the patient support apparatus 100 is in transport. The intravenous pole holder 232 may be arranged for rotation and pivoting to accommodate movement of the intravenous pole during transport of the patient support apparatus 100. For example, the intravenous pole holder 232 may be supported for pivoting movement about a holder axis HAX1 and for pivoting movement about a second holder axis HAX2 arranged at an angle relative to the holder axis HAX1. To this end, in the representative version depicted in FIG. 10, the receptacle 204 includes one or more pivot mounts 236 which support a guide 238 for pivoting movement about the holder axis HAX1 while the guide 238, in turn, supports the intravenous pole holder 232 for pivoting movement about the second holder axis HAX2 which is arranged transverse to the holder axis HAX1. Here, the guide 238 may include one or more limit slots 240 shaped and arranged to receive one or more corresponding limit protrusions 242 operatively attached to the intravenous pole holder 232. This configurations permits limited pivoting movement about the second holder axis HAX1 based on engagement of the limit protrusions in the limit slots 240. In this way, the intravenous pole holder 232 accommodates multiple degrees of freedom of movement of an intravenous pole received by the intravenous pole holder 232 during transport of the patient support apparatus 100. It should be noted that the angle between the holder axis HAX1 and the second holder axis HAX2 may vary depending on whether the receptacle 204 is disposed in the stowed position SP or in the use position UP, and whether the intravenous pole holder 232 has received an intravenous pole.

Several configurations have been discussed in the foregoing description. However, the configurations discussed herein are not intended to be exhaustive or limit the invention to any particular form. The terminology which has been used is intended to be in the nature of words of description rather than of limitation. Many modifications and variations are possible in light of the above teachings and the invention may be practiced otherwise than as specifically described.

The present disclosure also comprises the following clauses, with specific features laid out in dependent clauses, that may specifically be implemented as described in greater detail with reference to the configurations and drawings above.

### CLAUSES

I. A patient support apparatus for use in removably securing an oxygen bottle, the patient support apparatus comprising:
a base;
an intermediate frame supporting a patient support deck;
a lift mechanism coupled between the intermediate frame and the base to move the intermediate frame relative to the base between a plurality of vertical configurations;
a bottle holder assembly including:
   a mount operatively attached to the intermediate frame for concurrent movement between the plurality of vertical configurations, the mount defining a mount axis, and
   a carrier subassembly including:
      a carrier supported for pivoting movement about the mount axis;
      a receptacle defining an inlet to receive an end of the oxygen bottle along a receptacle axis; and
      a linkage supporting the receptacle for movement relative to the carrier between a stowed position defined with the receptacle axis disposed at a first angle relative to the mount axis, and a use position defined with the receptacle axis disposed at a second angle, smaller than the first angle, relative to the mount axis,
wherein the carrier subassembly is supported for pivoting movement relative to the mount about the mount axis between a plurality of carrier orientations including a stowed carrier orientation defined with the receptacle arranged adjacent to the intermediate frame and disposed in the stowed position, and one or more deployed carrier orientations defined with the receptacle spaced from the intermediate frame.
II. The patient support apparatus of clause I, wherein the mount axis is arranged adjacent to a corner of the intermediate frame, and wherein the carrier subassembly is supported for pivoting movement relative to the corner of the intermediate frame.
III. The patient support apparatus of clause II, wherein the carrier subassembly includes a detent mechanism defining a plurality of detents arranged about the mount axis, and a plunger arranged to engage each of the plurality of detents to maintain the carrier subassembly in a respective carrier orientation.
IV. The patient support apparatus of any preceding clause I, wherein, in the one or more deployed carrier orientations, the receptacle is disposed in the use position supporting the oxygen bottle along the receptacle axis.
V. The patient support apparatus of any preceding clause I, wherein the intermediate frame includes a foot end and a head end, wherein the plurality of carrier orientations includes a longitudinal deployed carrier orientation with the receptacle axis spaced longitudinally from the foot end.
VI. The patient support apparatus of any preceding clause I, wherein the intermediate frame includes a foot end and a head end, wherein the plurality of carrier orientations includes a lateral deployed carrier orientation with the receptacle axis spaced laterally from the foot end.
VII. The patient support apparatus of any preceding clause I, wherein the intermediate frame defines an intermediate frame footprint projected downward on a floor surface, wherein the receptacle is disposed at least partially within the intermediate frame footprint when the carrier subassembly is in the stowed carrier orientation.
VIII. The patient support apparatus of any preceding clause I, wherein the intermediate frame defines an intermediate frame footprint projected downward on a floor surface, wherein the receptacle is disposed outside of the intermediate frame foot print when the carrier subassembly is in a deployed carrier orientation.
IX. The patient support apparatus of any preceding clause I, further including a caregiver interface operatively attached to the intermediate frame adjacent to the bottle holder assembly.
X. The patient support apparatus of clause IX, wherein the caregiver interface includes a vertical post arranged parallel to and spaced from the mount axis.
XI. The patient support apparatus of any preceding clause I, wherein the linkage includes a first bar pivotably coupled to the receptacle and to the carrier, and a second bar spaced from the first bar and pivotably coupled to the receptacle and to the carrier; and
wherein the second bar is supported for pivoting movement between:
   a first position supporting the receptacle in the stowed position, and
   a second position supporting the receptacle in the use position.
XII. The patient support apparatus of clause XI, wherein the carrier subassembly includes a biasing mechanism configured to urge the receptacle toward the stowed position.
XIII. The patient support apparatus of clause XII, wherein the biasing mechanism includes a spring disposed adjacent to the second bar of the linkage and arranged to urge the second bar toward the first position to dispose the receptacle in the stowed position.
XIV. The patient support apparatus of any preceding clause I, wherein a weight of the oxygen bottle disposes the receptacle in the use position.
XV. The patient support apparatus of any preceding clause I, further including a biasing lever coupled to the receptacle and supported for movement between:
a first lever position to abut a side of an oxygen bottle of a first diameter, and
a second lever position to abut a side of an oxygen bottle of a second diameter, larger than the first diameter.
XVI. The patient support apparatus of clause XV, wherein the biasing lever is biased toward an initial lever position, and wherein a side of the oxygen bottle of the first diameter pivots the biasing lever from the initial lever position to the first lever position when the oxygen bottle of the first diameter is received by the receptacle.
XVII. The patient support apparatus of any preceding clause I, further including an intravenous pole holder coupled to the receptacle, the intravenous pole holder including a receiver for receiving an intravenous pole.
XVIII. The patient support apparatus of clause XVII, wherein the intravenous pole holder is supported for pivoting movement about a holder axis.
XIX. The patient support apparatus of clause XVIII, wherein the intravenous pole holder is further supported for pivoting movement about a second holder axis arranged at an angle relative to the holder axis.

1. A patient support apparatus for use in removably securing an oxygen bottle, the patient support apparatus comprising:
a base;
an intermediate frame supporting a patient support deck;
a lift mechanism coupled between the intermediate frame and the base to move the intermediate frame relative to the base between a plurality of vertical configurations;
a bottle holder assembly including:
a mount operatively attached to the intermediate frame for concurrent movement between the plurality of vertical configurations, the mount defining a mount axis, and
a carrier subassembly including:
a carrier supported for pivoting movement about the mount axis;
a receptacle defining an inlet to receive an end of the oxygen bottle along a receptacle axis; and
a linkage supporting the receptacle for movement relative to the carrier between a stowed position defined with the receptacle axis disposed at a first angle relative to the mount axis, and a use position defined with the receptacle axis disposed at a second angle, smaller than the first angle, relative to the mount axis,
wherein the carrier subassembly is supported for pivoting movement relative to the mount about the mount axis between a plurality of carrier orientations including a stowed carrier orientation defined with the receptacle arranged adjacent to the intermediate frame and disposed in the stowed position, and one or more deployed carrier orientations defined with the receptacle spaced from the intermediate frame.

2. The patient support apparatus of claim 1, wherein the mount axis is arranged adjacent to a corner of the intermediate frame, and wherein the carrier subassembly is supported for pivoting movement relative to the corner of the intermediate frame.

3. The patient support apparatus of claim 2, wherein the carrier subassembly includes a detent mechanism defining a plurality of detents arranged about the mount axis, and a plunger arranged to engage each of the plurality of detents to maintain the carrier subassembly in a respective carrier orientation.

4. The patient support apparatus of claim 1, wherein, in the one or more deployed carrier orientations, the receptacle is disposed in the use position supporting the oxygen bottle along the receptacle axis.

5. The patient support apparatus of claim 1, wherein the intermediate frame includes a foot end and a head end, wherein the plurality of carrier orientations includes a longitudinal deployed carrier orientation with the receptacle axis spaced longitudinally from the foot end.

6. The patient support apparatus of claim 1, wherein the intermediate frame includes a foot end and a head end, wherein the plurality of carrier orientations includes a lateral deployed carrier orientation with the receptacle axis spaced laterally from the foot end,

7. The patient support apparatus of claim 1, wherein the intermediate frame defines an intermediate frame footprint projected downward on a floor surface, wherein the receptacle is disposed at least partially within the intermediate frame footprint when the carrier subassembly is in the stowed carrier orientation.

8. The patient support apparatus of claim 1, wherein the intermediate frame defines an intermediate frame footprint projected downward on a floor surface, wherein the receptacle is disposed outside of the intermediate frame footprint when the carrier subassembly is in a deployed carrier orientation.

9. The patient support apparatus of claim 1, further including a caregiver interface operatively attached to the intermediate frame adjacent to the bottle holder assembly.

10. The patient support apparatus of claim 9, wherein the caregiver interface includes a vertical post arranged parallel to and spaced from the mount axis.

11. The patient support apparatus of claim 1, wherein the linkage includes a first bar pivotably coupled to the receptacle and to the carrier, and a second bar spaced from the first bar and pivotably coupled to the receptacle and to the carrier; and
wherein the second bar is supported for pivoting movement between:
a first position supporting the receptacle in the stowed position, and
a second position supporting the receptacle in the use position.

12. The patient support apparatus of claim 11, wherein the carrier subassembly includes a biasing mechanism configured to urge the receptacle toward the stowed position,

13. The patient support apparatus of claim 12, wherein the biasing mechanism includes a spring disposed adjacent to the second bar of the linkage and arranged to urge the second bar toward the first position to dispose the receptacle in the stowed position, 14. The patient support apparatus of claim 1, wherein a weight of the oxygen bottle disposes the receptacle in the use position.

15. The patient support apparatus of claim 1, further including a biasing lever coupled to the receptacle and supported for movement between:
a first lever position to abut a side of an oxygen bottle of a first diameter, and
a second lever position to abut a side of an oxygen bottle of a second diameter, larger than the first diameter.

16. The patient support apparatus of claim 15, wherein the biasing lever is biased toward an initial lever position, and wherein a side of the oxygen bottle of the first diameter pivots the biasing lever from the initial lever position to the first lever position when the oxygen bottle of the first diameter is received by the receptacle.

17. The patient support apparatus of claim 1, further including an intravenous pole holder coupled to the receptacle, the intravenous pole holder including a receiver for receiving an intravenous pole.

18. The patient support apparatus of claim 17, wherein the intravenous pole holder is supported for pivoting movement about a holder axis.

19. The patient support apparatus of claim 18, wherein the intravenous pole holder is further supported for pivoting movement about a second holder axis arranged at an angle relative to the holder axis.
